(19) United States
(12) Patent Application Publication
(10) Pub. No.: US 2025/0085681 A1
(43) Pub. Date: Mar. 13, 2025

(54) COMPUTER-IMPLEMENTED METHOD FOR ENERGY EFFICIENCY MANAGEMENT OF AN INDUSTRIAL PLANT

(71) Applicant: PINPOINT SRL, Bastiglia (MO) (IT)

(72) Inventors: Nicolò LUPPI, Bastiglia (MO) (IT); Sara MORANDI, Bastiglia (MO) (IT)

(21) Appl. No.: 18/825,684

(22) Filed: Sep. 5, 2024

(30) Foreign Application Priority Data
Sep. 8, 2023 (IT) 102023000018525

(51) Int. Cl. G05B 19/042

(52) U.S. Cl. CPC G05B 19/042; G05B 2219/2639

(57) ABSTRACT

The computer-implemented method for energy efficiency management of an industrial plant comprises at least the following steps: starting from a plurality of files relating to data sheets of industrial appliances, a step of extraction of the image files of graphs containing curves describing the technical characteristics of the industrial appliances; a step of determination of the characteristic equations of the curves, defined in the specific Cartesian space of each graph, starting from the image files of graphs; a step of calculating the energy consumption of each industrial appliance by means of said determined characteristic equations; a step of comparing the calculated energy consumption of each of the industrial appliances with the energy consumption of at least one industrial appliance in an existing industrial plant; if the energy consumption of the industrial plant can be reduced, or if, the energy consumption being the same, the efficiency of the industrial plant can be improved, then a step is carried out of generation of an alert and of a report comprising the suggested changes to the industrial appliance used in the industrial plant.

### TECHNICAL FIELD

The present invention relates to a computer-implemented method for energy efficiency management of an industrial plant.

### BACKGROUND ART

In particular, the computer-implemented method according to the invention can be used to check whether the energy consumption (or otherwise the efficiency) of at least one industrial appliance within an industrial plant is the optimal one and whether it can be improved, if necessary.

In this regard, the use of systems for monitoring industrial plants is well known.

Specifically, such monitoring systems allow for real-time detection of any failures or malfunctions and, in addition, allow for the collection of representative data on the operation of the monitored appliances.

For example, the use of industrial pumps for cooling and lubrication systems, for fluid transfer and within hydraulic systems is well-known and widely used in the industry.

The use of the aforementioned monitoring systems thus makes it possible to detect any malfunctions of the pumps and to detect their actual mode of use during plant operation.

However, the systems of known type do not allow for the management of plant energy consumption and, in particular, are unable to determine whether the energy consumption and/or energy efficiency of each appliance within the plant can be improved through the use of a different appliance and/or through a different setting of the appliance itself.

For example, with reference to industrial pumps, it is in no way possible, by means of the systems of known type, to determine whether the use of a different pump, possibly selected from products of several different suppliers, can result in better energy consumption and/or better efficiency.

Specifically, data for different industrial pumps are commonly collected in different data sheets and the technical operating characteristics of each pump are usually represented by means of multiple graphs.

Therefore, an assessment of the impact on energy consumption and efficiency as a result of using a different pump on a plant can only be carried out by a specialist in the field, who must in turn employ his or her expertise and a not insignificant amount of time to make a comparison between the pump installed on the plant and the available pumps taken into consideration.

Clearly, it is impossible for a trained technician to consider and evaluate all the pumps available on the market along an acceptable time frame.

### DESCRIPTION OF THE INVENTION

The main aim of the present invention is to devise a computer-implemented method for energy efficiency management of an industrial plant which makes it possible to check quickly and accurately whether the energy consumption or otherwise the efficiency of one or more industrial appliances within an industrial plant is the optimal one and whether it can be improved, if necessary, by the use of a different appliance available on the market.

The aforementioned objects are achieved by this computer-implemented method for energy efficiency management of an industrial plant according to the characteristics described in claim 1.

### BRIEF DESCRIPTION OF THE DRAWINGS

Other characteristics and advantages of the present invention will become more apparent from the description of a preferred, but not exclusive, embodiment of a computer-implemented method for energy efficiency management of an industrial plant, illustrated by way of an indicative, yet non-limiting example in the accompanying tables of drawings in which:

FIG. 1 is a general diagram of the computer-implemented method according to the invention;

FIGS. 2 through 11 are functional diagrams detailing the computer-implemented method according to the invention.

### EMBODIMENTS OF THE INVENTION

With particular reference to these figures, reference numeral 1 globally denotes a computer-implemented method for energy efficiency management of an industrial plant which can be used in particular to check whether the energy consumption (or otherwise the efficiency) of at least one industrial appliance within an industrial plant is the optimal one and whether it can be improved, if necessary.

The term “industrial appliance” refers to all appliances or devices that can be used industrially on a plant.

With reference to a preferred application, the computer-implemented method according to the invention is used to manage the energy efficiency of industrial pumps, meant to be the pumps widely used in the industry to provide cooling and lubrication services, to transfer fluids and to provide motive power to hydraulic systems.

Industrial pumps consist of a pump system moved by an electric motor.

In the following description and in the related figures, explicit reference will be made to the operation of industrial pumps, without ruling out the application of the computer-implemented method according to the invention to different types of appliance and device that can be used on an industrial plant.

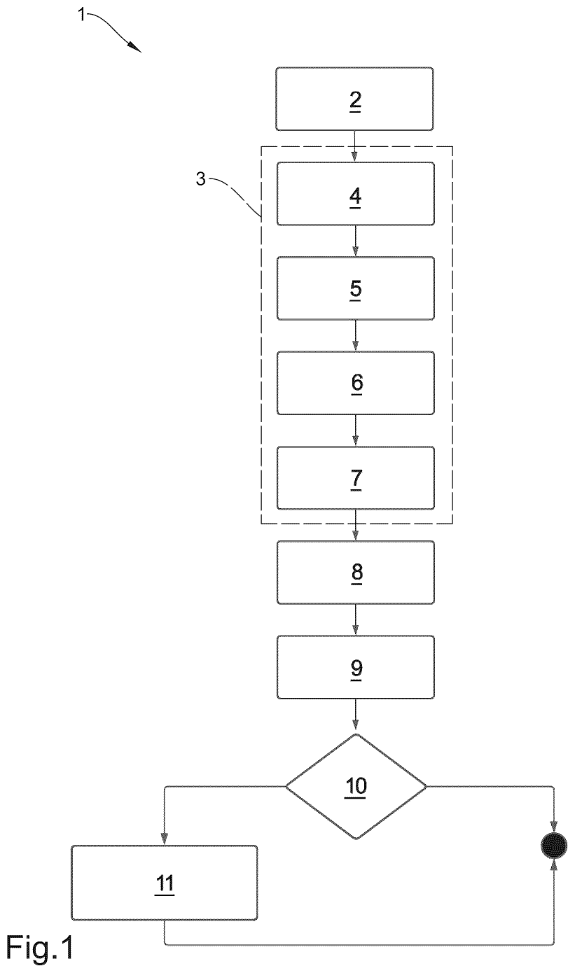

As schematically shown in FIG. 1, the computer-implemented method 1 comprises at least the following steps:
starting from a plurality of files relating to data sheets of industrial appliances, a step 2 of extraction of the image files of graphs G containing curves C describing the technical characteristics of the industrial appliances and of text files relating to the description of the industrial appliances;
a step 3 of determination of the characteristic equations of the curves C, defined in the specific Cartesian space of each graph, starting from the image files of graphs G;
a step 8 of calculating the energy consumption of each industrial appliance by means of the determined characteristic equations;
a step 9 of comparing the calculated energy consumption of each of the industrial appliances with the energy consumption of at least one industrial appliance in an existing industrial plant.

As a result of this comparison, if the energy consumption of the industrial plant can be reduced (step 10) or if, the energy consumption being the same, the efficiency of the industrial plant can be improved, then a step 11 is carried out of generation of an alert and of a report comprising the suggested changes to the industrial appliance used in the industrial plant.

The step 3 of determination of the characteristic equations of the curves C defined in the specific Cartesian space of each graph is further detailed again in FIG. 1.

Specifically, the aforementioned step 3 of determination of the characteristic equations comprises a step 4 of identification of the images of the curves C representative of the technical characteristics of the industrial appliances starting from the image files of the graphs G.

Next, the step 3 of determination of the characteristic equations comprises a step 5 of extraction and rearrangement of the spatial coordinates of the pixels of the images of the representative curves C to determine the spatial coordinates of each of the curves C.

In addition, the step 3 of determination of the characteristic equations comprises a step 6 of extraction of the equations relating to the curves C by means of interpolation of the spatial coordinates of each of the curves C.

Next, the step 3 of determination of the characteristic equations comprises a step 7 of extraction of the scale of values representing the x-axis and y-axis starting from the image files of the graphs G.

Finally, the step 3 of determination of the characteristic equations comprises a step of combining the equations extracted by interpolation of the spatial coordinates of each of the curves C with the scale of values representing the x-axis and y-axis to obtain the characteristic equations of the curves C defined in the specific Cartesian space of each graph G.

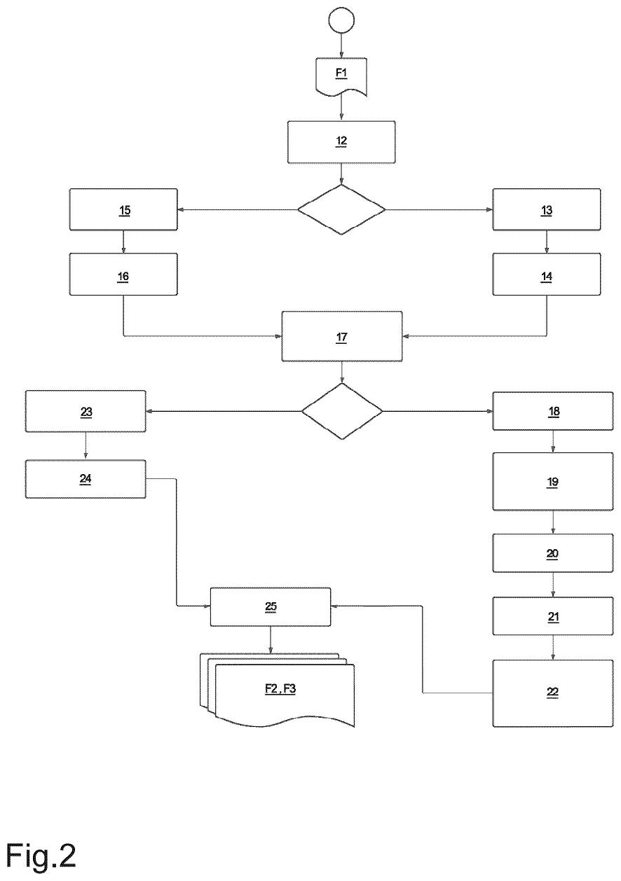

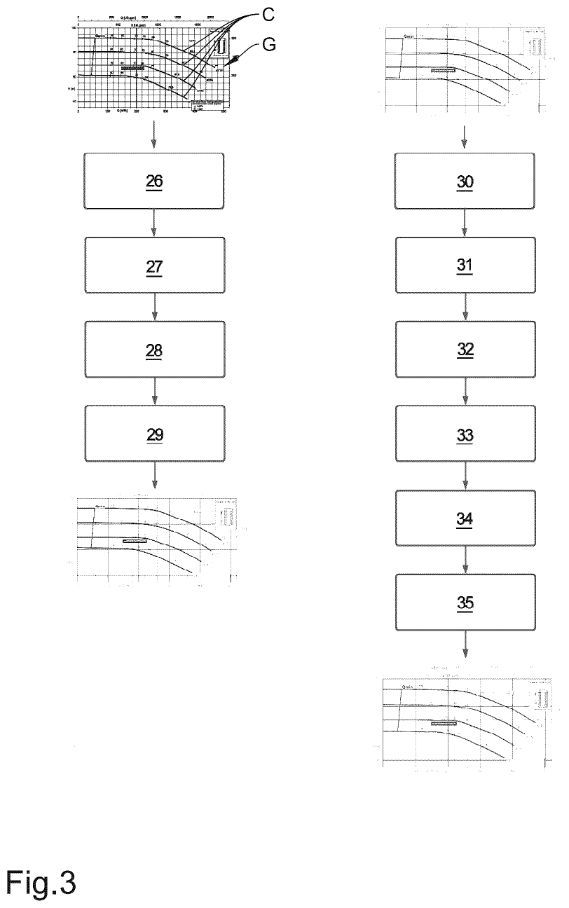

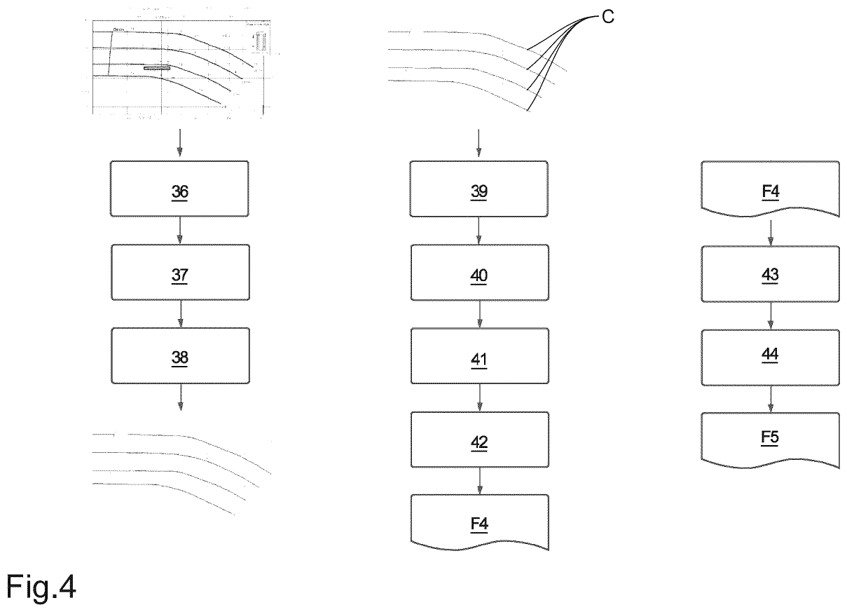

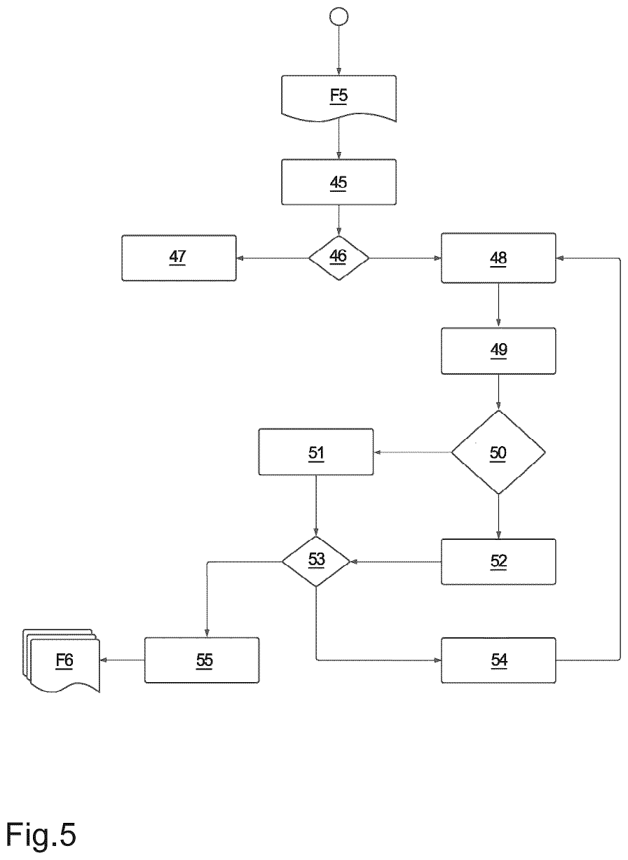

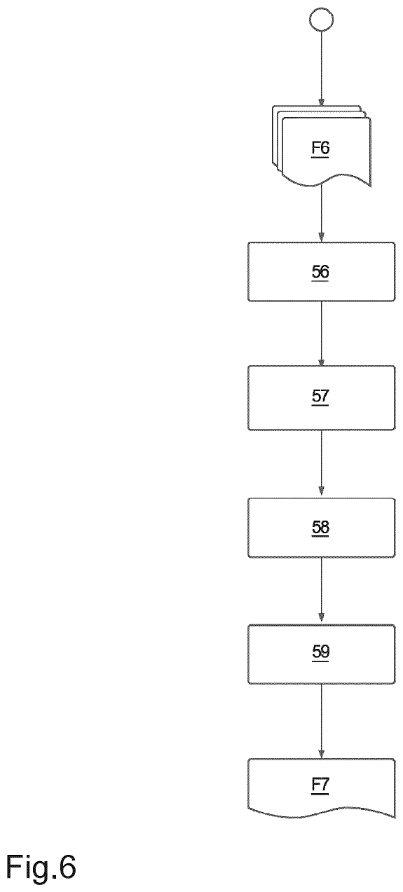

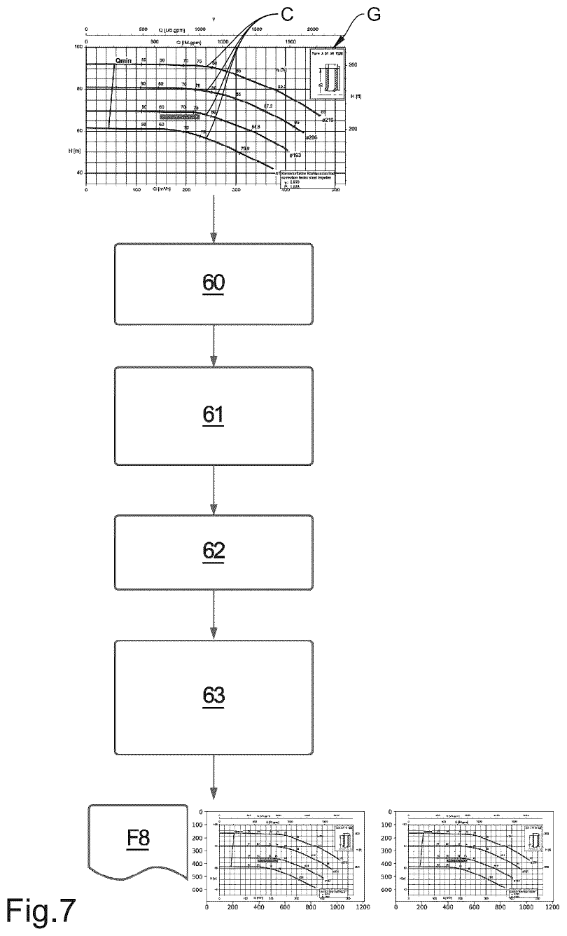

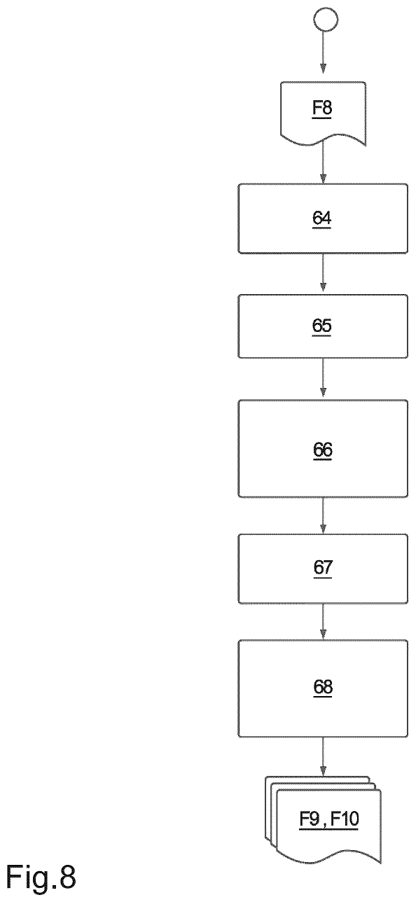

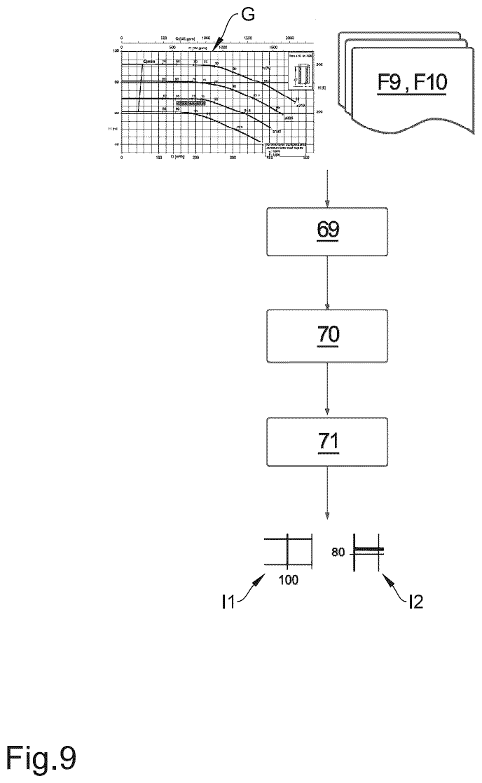

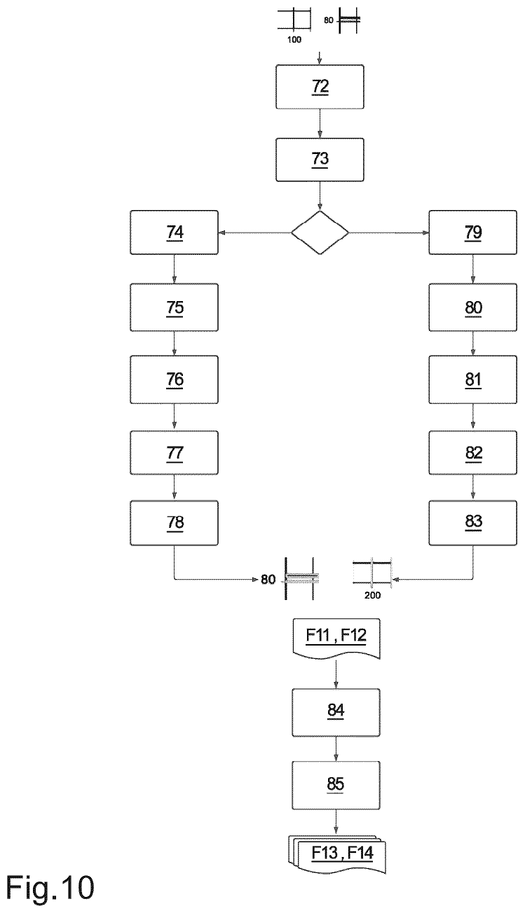

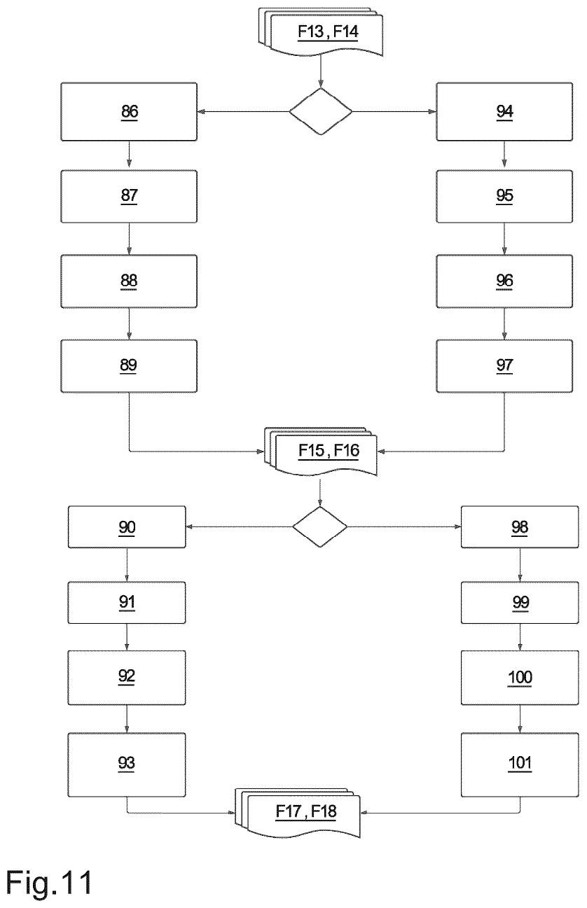

A possible and preferred embodiment of the steps described above is detailed below. These steps are also schematically detailed in FIGS. 2 through 11.

According to a preferred embodiment, the files relating to the data sheets of the industrial appliances are in PDF format.

As shown in FIG. 2, the step 2 of extraction comprises a preliminary step 12 of separating the pages of the PDF file, indicated in the figure by reference F1, and saving each page to a respective file in JPG format.

Next, the step of extraction 2 comprises at least the following steps:
by means of a neural network, recognize within the files relating to data sheets the graphs G relating to the technical characteristics of the industrial appliances (step 13);
save a plurality of image files relating to the recognized graphs G (step 14).

Specifically, according to the preferred embodiment, the neural network used recognizes the graphs G within the JPG files containing the individual pages of the data sheets.

For example, the neural network can be implemented by means of a neural network for YOLOv5 image processing.

Once recognized, the graphs G are cropped and each crop is saved to a respective image file in JPG format.

Next, the step 2 of extraction comprises at least the following steps:
by means of a neural network, recognize within the files relating to data sheets a description of the industrial appliances (step 15);
save a plurality of image files relating to the recognized descriptions (step 16).

Specifically, according to the preferred embodiment, the neural network used recognizes the descriptions relating to the industrial appliances within the JPG files containing the individual pages of the data sheets.

For example, the second neural network can be implemented by means of a neural network for YOLOv8 image processing.

Once recognized, the descriptions are cropped and each crop is saved to a respective image file in JPG format.

Next, a step 17 is carried out of creation of a unique folder with multiple subfolders and of saving within each of these subfolders the image files of graphs G and of the descriptions relating to the same page of a data sheet.

With reference to the image files relating to the graphs G, the step 2 of extraction comprises the conversion of the images to grayscale (step 18).

In addition, the step 2 of extraction comprises a step 19 of kernel sharpening to improve the quality of the images relating to the graphs (G).

Next, the step 2 of extraction comprises at least the following steps:
by means of an OCR software module, recognize the text within the images relating to the graphs G (step 20);
compare the recognized text with predefined words relating to a specific type of graph (step 21);
when the recognized text matches a predefined word, classify the corresponding image as relating to a specific type of graph and rename an image file F2 relating to that graph according to the specific type (step 22).

For example, with specific reference to the use of the method 1 according to the invention for energy efficiency management of industrial pumps, the recognized text is compared with predefined words comprising NPSH, H[m], P[KW] and, in case of correspondence, the images are classified according to the following type of graphs (G):
NPSH corresponds to a graph showing the net positive suction head of a pump;
H[m] corresponds to a graph showing the head of the pump flow rate;
P[KW] corresponds to a graph showing the trend of the pump power (cavitation).

The corresponding image files relating to the graphs G are renamed as NPSH.jpg, prevalence.jpg and power.jpg, respectively.

With reference to the image files relating to the description of the industrial appliances, each file within each subfolder is analyzed and, specifically, the step 2 of extraction comprises at least the following steps:
by means of an OCR software module, recognize the text within the images relating to the description of the industrial appliances (step 23);
creation and saving of text files F2 relating to the description (step 24).

The step 2 of extraction ends up with the creation of a folder for each page of the pdf data sheet, containing a descriptive image, the renamed images of the graphs G and the text files, preferably in csv format, containing the description (step 25).

Preferably, the step 4 of identification comprises a first step 26 of conversion of the images to grayscale relating to the graphs G to reduce the complexity of the images themselves.

In addition, for each image, the step 4 of identification comprises a step 27 of creation of a kernel of size 3×3.

Next, the step 4 of identification comprises at least the following steps:
for each image relating to a graph G, carry out a morphological transformation to increase the white regions of the image and decrease the black regions (step 28);
for each transformed image, apply an image threshold, wherein all pixels with intensity value less than a predefined threshold value, preferably equal to 32, become black (value 0) and all others white (value 255) (step 29).

Preferably, the step 4 of identification subsequently involves an additional step 30 of conversion the obtained images to grayscale.

In addition, the step 4 of identification comprises at least the following steps:
set a predefined intensity value of the pixels, preferably equal to 55 (step 31);
for each transformed image and to which the image threshold has been applied, recognize all pixels with lower intensity than the predefined intensity value (step 32);
collect all recognized pixels into an array and create a binary mask in which the pixels with lower predefined intensity value (55) are set to TRUE, while the remaining are set to FALSE (steps 33 and 34),
for each transformed image and to which the image threshold has been applied, use the mask created to color the pixels set to TRUE with a predefined color (e.g. color (0,119,204) in BGR format) (step 35).

According to a preferred embodiment, for each image with colored pixels, the step 4 of identification comprises a step 36 of conversion from the color space BGR to the color space HSV to enable better color-based segmentation.

In addition, the step 4 of identification comprises at least the following steps:
creation of a binary mask to isolate a specific color range (step 37);
for each obtained image with colored pixels, apply the binary mask to make white all pixels that do not match (the binary mask created and, therefore, do not match) the colored pixels (step 38);
The next step 5 of extraction and rearrangement involves the following preliminary steps:
apply a predefined threshold value (preferably equal to 90) to the grayscale image in order to create a binary mask (step 39);
apply the mask to the image with the colored pixels with a bit-to-bit “AND” operation so that the colored pixels are isolated (step 40).

In addition, the step 5 of extraction and rearrangement of the spatial coordinates comprises at least the following steps:
extraction of the spatial coordinates of the colored pixels from the image with the colored pixels (step 41);
saving the extracted spatial coordinates to an F4 file, preferably a csv file (step 42);
sorting the extracted coordinates with respect to the x column (step 43);
creation of a new F5 save file, preferably of csv type with the coordinates sorted according to the x column (step 44);
In addition, the step 5 of extraction and rearrangement of the spatial coordinates comprises at least the following steps carried out cyclically:
read a coordinate from the F5 file with the coordinates sorted according to the x column (step 45);
if the read coordinate is a first coordinate (step 46), create a new file, preferably a csv file (step 47);
if the read coordinate is not a first coordinate (step 46), calculate the Euclidean distance between the read coordinate and the last coordinate in each file (step 48);
locate the file in which the last coordinate is closest to the read coordinate (step 49);
if the distance of the read coordinate is less than a predefined threshold distance (step 50), enter the read coordinate at the end of the detected file (step 51);
if the distance of the read coordinate is greater than the predefined threshold distance (step 50), create a new file relating to a different curve and save the read coordinate (step 52);
if each coordinate within the file has not been read (step 53), read the next coordinate and return to the step 48 of calculating the Euclidean distance between the read coordinate and the last coordinate in each file (step 54);
if all coordinates within the file have been read (step 53), delete the files with less than a predefined number of coordinates, preferably 30 (step 55).

Thus, for each of the graphs G, the files containing isolated points are deleted and as many F6 files are created as there are curves C within a graph G.

The step 6 of extraction of the equations comprises at least the following steps:
for each of the F6 files relating to each of the curves C, apply a regression function (preferably a polynomial regression) to approximate the represented curves C (step 56);
possibly, a step of adjustment of the y-axis coordinates according to the model of the curves (step 57);
creation of a descriptive function (preferably of a tenth-degree polynomial) of the trend of each curve (step 58);
saving the descriptive function (preferably polynomial expressions) obtained for each curve to an F7 file, preferably of the txt type (step 59).

Next step 7 of extraction of the scale of values comprises a preliminary step 60 of image conversion from color space BGR to color space RGB for more accurate image display.

In addition, the step 7 of extraction of the scale of values comprises at least the following steps, carried out for each image of a graph G:
apply an algorithm of optical character recognition (OCR), preferably using a Deep Neural network, to identify the text within the image (step 61);
create a new image comprising boxes drawn around the recognized text (step 62);
save the data to a new output file F8 (preferably of the csv type) containing the recognized text and the coordinates of the corresponding bounding boxes (step 63);
read the output file F8 starting from the last row and sort the coordinates of the boxes in ascending order with respect to the x-axis (step 64);
write the last element of the file into a new first file F9 (again preferably of the CSV type) (step 65);
compare each y-coordinate of each row read from the output file F8 with the y-coordinate of the point entered in the first file F9; if the difference between the two y-coordinates is less than a predefined distance (preferably 5), add the coordinates of the point read to the first file (step 66);
identify a point with the minor x-coordinate from the output file F8 and write the coordinates of the identified point into a new second file 10 (again preferably of the CSV type) (step 67);
compare each x-coordinate of each row in the second file F10 with the x-coordinate of the identified point; if the difference between the two x-coordinates is less than a predefined distance (preferably 5) the point is added to the second file F10 (step 68).

Next, the step 7 of extraction of the scale of values comprises at least the following steps:
read the first and second files (step 69);
for coordinates representing y-axis values, crop a first image I1 (preferably at the position x1=x1, y1=y1−65, x2=x2+20, y2=y2) so as to highlight the region of the graph G relating to the individual value (step 70);
for the coordinates representing x-axis values, crop a second image 12 (preferably at the position x1=x1−20, y1=y1−65, x2=x2+20, y2=y2) so as to highlight the region of the graph G relating to the individual value (step 71).

Next, the step 7 of extraction of the scale of values comprises a step 72 of conversion of the obtained crops to grayscale.

In addition, a step 73 is carried out of applying one Otsu threshold for image binarization.

In addition, with reference to the y-axis and starting from the first cropped image I1, the step 7 of extraction of the scale of values comprises at least the following steps:
create a horizontal kernel (step 74);
perform a morphological operation to remove noise and isolate the horizontal lines (step 75);
search for horizontal contours relating to the horizontal lines and extract the relevant coordinates (step 76);
highlight the horizontal contours found on the first cropped image (step 77);
save a file containing the extracted coordinates relating to the horizontal contours (step 78).

With reference instead to the x-axis and starting from said second cropped image 12, the step 7 of extraction of the scale of values comprises at least the following steps:
create a vertical kernel (step 79);
perform a morphological operation to remove noise and isolate the vertical lines (step 80);
search for vertical contours relating to the vertical lines and extract the relevant coordinates (step 81);
highlight the vertical contours found on the second cropped image (step 82);
save a file F12 containing the extracted coordinates relating to the vertical contours (step 83).

Next, the step 7 of extraction of the scale of values comprises at least the following steps, performed starting from files F11 and F12 containing the extracted coordinates relating to the horizontal contours and to the vertical contours:
read all the lines in the file and write the elements into a new file until an empty line is found (step 84);
if the line read is an empty line, then create a new file (preferably of the csv type) and repeat the previous step (step 85).

In this way, a different file is obtained for each x-axis value and for each y-axis value containing the coordinates of the recognized horizontal and vertical lines.

In addition, the step 7 of extraction of the scale of values comprises at least the following steps, with reference to the y-axis and starting from the files F13 containing the coordinates of the recognized horizontal lines:
initialize an empty data frame to store the distances between the horizontal lines and the bounding boxes (step 86);
calculate all the distances between the bounding boxes and the coordinates of the recognized horizontal lines contained in the files (step 87);
select the minimum distance corresponding to the horizontal line identifying the point of a value on the y-axis (step 88);
save the results to a file F15 (step 89);
read the first two values of the file F15 (step 90);
calculate the number of pixels between the two values identified by the horizontal lines recognized along the y-axis (step 91);
calculate the value of each unit, that is, how much each pixel is worth, by making the difference between the y-axis values divided by the number of pixels between the two values (step 92);
save the values of each unit relating to the y-axis to a file F17 (step 93).

Finally, with reference to the x-axis and starting from the files F14 containing the coordinates of the recognized vertical lines, the step 7 of extraction of the scale of values comprises at least the following steps:
initialize an empty data frame to store the distances between the vertical lines and said bounding boxes (step 94);
calculate all distances between the bounding boxes and the coordinates of the recognized vertical lines contained in the files (step 95);
select the minimum distance corresponding to the vertical line identifying the point of a value on the x-axis (step 96);
save the results to a file F16 (step 97);
read the first two values of the file (step 98);
calculate the number of pixels between the two values identified by the vertical lines recognized along the x-axis (step 99);
calculate the value of each unit, that is, how much each pixel is worth, by making the difference between the x-axis values divided by the number of pixels between the two values (step 100);
save the values of each unit relating to the x-axis to a file F18 (step 101).

It has in practice been ascertained that the described invention achieves the intended objects.

In particular, the fact is emphasized that the computer-implemented method according to the invention makes it possible to check quickly and accurately whether the energy consumption or otherwise the efficiency of one or more industrial appliances within an industrial plant is the optimal one and whether it can be improved, if necessary, by using a different appliance available on the market.

Specifically, the method according to the invention makes it possible to automatically extract the data relating to different appliances directly from the images of the graphs on the data sheets.

This allows the extracted information to be used to assess the energy efficiency of the appliances on a plant, assessing and signaling the possibility of possible replacement.

1. Computer-implemented method (1) for energy efficiency management of an industrial plant, characterized by the fact that it comprises at least the following steps:
starting from a plurality of files relating to data sheets of industrial appliances, a step (2) of extraction of the image files of graphs (G) containing curves (C) describing the technical characteristics of the industrial appliances;
a step (3) of determination of the characteristic equations of said curves (C), defined in the specific Cartesian space of each graph, starting from said image files of graphs (G);
a step (8) of calculating the energy consumption of each industrial appliance by means of said determined characteristic equations;
a step (9) of comparing the calculated energy consumption of each of the industrial appliances with the energy consumption of at least one industrial appliance in an existing industrial plant:
if the energy consumption of the industrial plant can be reduced (step 10), or if, the energy consumption being the same, the efficiency of the industrial plant can be improved, then a step (11) is carried out of generation of an alert and of a report comprising the suggested changes to the industrial appliance used in the industrial plant.

2. Computer-implemented method (1) according to claim 1, characterized by the fact that said step (3) of determination of the characteristic equations comprises a step (4) of identification of images of the curves (C) representative of the technical characteristics of said industrial appliances starting from said image files of the graphs (G).

3. Computer-implemented method (1) according to claim 2, characterized by the fact that said step (3) of determination of the characteristic equations comprises a step (5) of extraction and rearrangement of the spatial coordinates of the pixels of said images of the representative curves (C) to determine the spatial coordinates of each of the curves (C).

4. Computer-implemented method (1) according to claim 3, characterized by the fact that said step (3) of determination of the characteristic equations comprises a step (6) of extraction of the equations relating to said curves (C) by means of interpolation of said spatial coordinates of each of the curves (C).

5. Computer-implemented method (1) according to claim 4, characterized by the fact that said step (3) of determination of the characteristic equations comprises a step (7) of extraction of the scale of values representing the x-axis and y-axis starting from said image files of the graphs (G).

6. Computer-implemented method (1) according to claim 5, characterized by the fact that said step (3) of determination of the characteristic equations comprises a step of combining the equations extracted by interpolation of said spatial coordinates of each of the curves (C) with the scale of values representing the x-axis and y-axis, to obtain said characteristic equations of the curves (C) defined in the specific Cartesian space of each graph (G).

7. Computer-implemented method (1) according to claim 1, characterized by the fact that said step (2) of extraction comprises at least the following steps:
by means of a neural network, recognize within said files relating to data sheets the graphs (G) relating to the technical characteristics of the industrial appliances (step 13);
save a plurality of image files relating to the recognized graphs (G) (step 14).

8. Computer-implemented method (1) according to claim 1, characterized by the fact that said step (4) of identification comprises at least the following steps:
for each image relating to a graph (G), carry out a morphological transformation to increase the white regions of the image and decrease the black regions (step 28);
for each transformed image, apply an image threshold, wherein all pixels with intensity value less than a predefined threshold value become black and all others white (step 29).
set a predefined intensity value of the pixels (step 31);
for each transformed image and to which the image threshold has been applied, recognize all pixels with lower intensity than said predefined intensity value (step 32);
collect all recognized pixels into an array and create a binary mask in which the pixels with lower predefined intensity value are set to TRUE, while the remaining are set to FALSE (steps 33 and 34),
for each transformed image and to which the image threshold has been applied, use the mask created to color the pixels set to TRUE with a predefined color (step 35).
creation of a binary mask to isolate a specific color range (step 37);
for each obtained image with colored pixels, apply the binary mask to make white all pixels that do not match the colored pixels (step 38);

9. Computer-implemented method (1) according to claim 1, characterized by the fact that said step (5) of extraction and rearrangement of the spatial coordinates comprises at least the following steps:
extraction of the spatial coordinates of the colored pixels from said image with the colored pixels (step 41);
saving the extracted spatial coordinates to a file (step 42);
sorting the extracted coordinates with respect to the x column (step 43);
creation of a new save file with the coordinates sorted according to the x column (step 44);
read a coordinate from said file with the coordinates sorted according to the x column (step 45);
if the read coordinate is a first coordinate (step 46), create a new file (preferably of the csv type) (step 47);
if the read coordinate is not a first coordinate (step 46), calculate the Euclidean distance between the read coordinate and the last coordinate in each file (step 48);
locate the file in which the last coordinate is the closest to the read coordinate (step 49);
if the distance of the read coordinate is less than a predefined threshold distance (step 50), enter the read coordinate at the end of the detected file (step 51);
if the distance of the read coordinate is greater than said predefined threshold distance (step 50), create a new file relating to a different curve and save the read coordinate (step 52);
if each coordinate within the file has not been read (step 53), read the next coordinate and return to said step (48) of calculating the Euclidean distance between the read coordinate and the last coordinate in each file (step 54);
if all coordinates within the file have been read (step 53), delete the files with less than a predefined number of coordinates (preferably 30) (step 55).

10. Computer-implemented method (1) according to claim 1, characterized by the fact that said step (6) of extraction of the equations comprises at least the following steps:
for each of the files relating to each of the curves (C), apply a regression function to approximate the represented curves (C) (step 56);
creation of a descriptive function of the trend of each curve (step 58);
saving the descriptive functions obtained for each curve to a file (step 59).

11. Computer-implemented method (1) according to claim 1, characterized by the fact that said step (7) of extraction of the scale of values comprises at least the following steps, carried out for each image of a graph (G):
apply an algorithm of optical character recognition (OCR) to identify the text within the image (step 61);
create a new image comprising boxes (R) drawn around the recognized text (step 62);
save the data to a new output file containing the recognized text and the coordinates of the corresponding bounding boxes (R) (step 63);
read the output file starting from the last row and sort the coordinates of the boxes (R) in ascending order with respect to the x-axis (step 64);
write the last element of the file into a new first file (step 65);
compare each y-coordinate of each row read from the output file with the y-coordinate of the point entered in the first file; if the difference between the two y-coordinates is less than a predefined distance, add the coordinates of the point read to the first file (step 66);
identify a point with the minor x-coordinate from the output file and write the coordinates of the identified point to a new second file (step 67);
compare each x-coordinate of each row in the second file with the x-coordinate of the identified point; if the difference between the two x-coordinates is less than a predefined distance, the point is added to the second file (step 68).
read said first and second files (step 69);
for coordinates representing y-axis values, crop a first image so as to highlight the region of the graph (G) relating to the individual value (step 70);
for coordinates representing x-axis values, crop a second image so as to highlight the region of the graph (G) relating to the individual value (step 71).

12. Computer-implemented method (1) according to claim 1, characterized by the fact that said step (7) of extraction of the scale of values comprises at least the following steps, with reference to the y-axis and starting from said first cropped image:
create a horizontal kernel (step 74);
perform a morphological operation to remove noise and isolate the horizontal lines (step 75);
search for horizontal contours relating to the horizontal lines and extract their coordinates (step 76);
highlight the horizontal contours found on the first cropped image (step 77);
save a file containing the extracted coordinates relating to the horizontal contours (step 78).

13. Computer-implemented method (1) according to claim 1, characterized by the fact that said step (7) of extraction of the scale of values comprises at least the following steps, with reference to the x-axis and starting from said second cropped image:
create a vertical kernel (step 79);
perform a morphological operation to remove noise and isolate the vertical lines (step 80);
search for vertical contours relating to the vertical lines and extract their coordinates (step 81);
highlight the vertical contours found on the second cropped image (step 82);
save a file containing the extracted coordinates relating to the vertical contours (step 83).

14. Computer-implemented method (1) according to claim 1, characterized by the fact that said step (7) of extraction of the scale of values comprises at least the following steps, with reference to the y-axis and starting from the files containing the coordinates of the recognized horizontal lines:
initialize an empty dataframe to store the distances between the horizontal lines and said bounding boxes (R) (step 86);
calculate all the distances between the bounding boxes (R) and the coordinates of the recognized horizontal lines contained in the files (step 87);
select the minimum distance corresponding to the horizontal line identifying the point of a value on the y-axis (step 88);
save the results to a file (step 89);
read the first two values in the file (step 90);
calculate the number of pixels between the two values identified by the horizontal lines recognized along the y-axis (step 91);
calculate the value of each unit, that is, how much each pixel is worth, by making the difference between the y-axis values divided by the number of pixels between the two values (step 92);
save the values of each unit relating to the y-axis (step 93).

15. Computer-implemented method (1) according to claim 1, characterized by the fact that said step (7) of extraction of the scale of values comprises at least the following steps, with reference to the x-axis and from the files containing the coordinates of the recognized vertical lines:
initialize an empty dataframe to store the distances between vertical lines and said bounding boxes (R) (step 94);
calculate all distances between the bounding boxes (R) and the coordinates of the recognized vertical lines contained in the files (step 95);
select the minimum distance corresponding to the vertical line identifying the point of a value on the x-axis (step 96);
save the results to a file (step 97);
read the first two values in the file (step 98);
calculate the number of pixels between the two values identified by the vertical lines recognized along the x-axis (step 99);
calculate the value of each unit, that is, how much each pixel is worth, by making the difference between the x-axis values divided by the number of pixels between the two values (step 100);
save the values of each unit relating to the x-axis (step 101).
